(19) United States
(12) Patent Application Publication
(10) Pub. No.: US 2011/0281011 A1
(43) Pub. Date: Nov. 17, 2011

(54) NON-DAIRY, NON-SOY WHIPPABLE FOOD PRODUCT WITH FRUIT JUICE AND METHOD OF MAKING

(76) Inventor: Rose Anne Colavito, Albany, NY (US)

(21) Appl. No.: 13/195,192

(22) Filed: Aug. 1, 2011

Related U.S. Application Data
(63) Continuation-in-part of application No. 12/660,349, filed on Feb. 25, 2010.
Application No. 12/660,349 is a continuation-in-part of application No. 11/539,834, filed on Oct. 9, 2006, now Pat. No. 7,776,377.
Application No. 11/539,834 is a continuation-in-part of application No. 11/071,077, filed on Mar. 3, 2005, now Pat. No. 7,592,030.
Application No. 11/071,077 is a continuation-in-part of application No. 11/438,525, filed on May 22, 2006, now Pat. No. 7,507,432.
Application No. 11/438,525 is a continuation-in-part of application No. 11/071,077, filed on Mar. 3, 2005, now Pat. No. 7,592,030.

(51) Int. Cl. A23L 1/09

(52) U.S. Cl. 426/572; 426/564

(57) ABSTRACT

A whippable food product and a method of making the same are disclosed. The finished product is packaged by an aseptic packaging process. It is shelf-stable (ingredients do not degrade or segregate during storage) at ambient temperatures for an extended period of time, and it whips stiff to form a uniform creamy topping in a short period of time. The product is free of dairy and animal products/by-products, thus suitable for vegan, kosher, or vegetarian consumption. Also, the product does not contain soy products and/or questionable ingredients such as processed oils or chemical additives, etc. Fruit juice or another acidulant is added to the product for extending the whipping potential of the food product and adding fruit flavoring.

### CROSS-REFERENCE TO RELATED APPLICATIONS

The present invention is a continuation-in-part of U.S. patent application Ser. No. 12/660,349 filed Feb. 25, 2010, which is a continuation-in-part of U.S. Pat. No. 7,776,377 filed Oct. 9, 2006, which is a continuation-in-part of U.S. Pat. No. 7,592,030 filed Mar. 3, 2005 and U.S. Pat. No. 7,507,432 filed May 22, 2006, which is a continuation-in-part of U.S. patent application Ser. No. 11/071,077 filed Mar. 3, 2005. The above patent applications and patents contain subject matter related, in certain aspects, to the subject matter of the present invention. The disclosures of these patents and patent applications are therefore incorporated by reference in the specification of the present invention.

### TECHNICAL FIELD

This application relates generally to food products for human consumption. In particular, it pertains to a non-dairy, non-soy food product, and a method of making said food product.

### BACKGROUND

Whipped topping is a food product that is made to resemble the taste, texture, and look of whipped dairy cream. Typically, whipped topping products contain some amount of oil (including partially hydrogenated oils and/or trans fats), dairy or non-dairy protein, a sweetener, and some other ingredients. In the U.S. market, a well-known brand of whipped topping is Cool Whip®.

Whipped topping products sold in food stores are usually pre-whipped (i.e. forming an air-liquid colloid before sold to consumers), hence lightweight and voluminous, and need to be constantly refrigerated or frozen before use. Alternatively, whipped toppings may be packaged in pressurized aerosol cans, which may or may not need refrigeration. However, the aerosol-canned products typically contain nitrous oxide propellant that may have adverse health effects, and the packaging materials are non-disposable. On the other hand, since the whipped topping products typically contain dairy products, soy products, or both, people with special needs, such as kosher parve, vegan, people with high cholesterol levels, or people allergic to certain dairy or soy, may not be able to consume these products. It is now known that the restriction of, or abstention from, certain foods may have a direct impact on the health of those engaged in certain practices. Some effects have been found to be positive, as in the case of vegetarian diets, which are eaten by many Seventh-day Adventists, Hindus, Buddhists, and Rastafarians.

In recent years, some new products in the whipped topping category have been developed to reduce or eliminate unhealthy ingredients for people with certain health conditions and special needs, and to make the storage and transportation of the products more convenient and cost effective. For instance, some products now are sold as un-whipped mixtures in relatively small packages. An end user may whip the mixture into whipped topping at home. Although these products still require refrigeration, their costs of storage and transportation are lower than that of the pre-whipped products.

Various dairy-free whipped topping products are now available on the market. One example of the dairy-free whippable toppings is “Soyatoo! Whippable Soy Topping.” This product contains organic soymilk and vegetarian organic fats (manufactured in Germany and imported by Ceres Organics St. Paul, Minn., website: “http://www.soyatoo.de/”). It is an un-whipped emulsion, and according to the manufacturer's instructions, must be kept under constant refrigeration. Although the manufacturer claims this product does not contain dairy products, as the name indicates, it contains soy products that may not be consumable by those allergic to soy, and it may contain processed oils like hydrogenated oils. The same company also sells two other non-dairy whipped topping products in pressurized aerosol cans, namely “Soyatoo! Soy Whip” and “Soyatoo! Rice Whip,” both of which contain nitrous oxide propellant.

Another example of non-dairy whipped topping products is “Rich's Whip Topping®” (website: “http://www.whiptopping.com/products.cfm?dsp=1”). This product is sold in both un-whipped and pre-whipped forms. The un-whipped product requires constant refrigeration at 0 degree Fahrenheit (−18° C.) or below prior to use. Shelf-life of the refrigerated un-whipped product is only about 12 months.

Aside from the fact that the above-mentioned whipped topping products may contain hydrogenated oils (consumption of hydrogenated oil has been linked with diabetes, coronary disease, and obesity in a number of scientific studies), they may also contain several questionable additives/ingredients such as polysorbate 60 (known to cause cancer in animals) or high fructose corn syrup (HFCS), etc. (Source: Eat Safe by Bill Statham, Running Press). Note that “questionable” is used herein to mean that there is doubt among nutrition and food experts as to the safety of consuming a particular ingredient or food product).

The reason that commonly available un-whipped topping must be kept under refrigeration is that the ingredients in the emulsified liquid mixture may degrade in ambient temperatures, thus significantly affecting its taste and reducing its shelf life. Although Perks (U.S. Pat. No. 7,351,440, assigned to Rich Products Corporation) has disclosed a topping product that can be stored at ambient temperatures for an extended period of time, and can be whipped and displayed at ambient temperatures, the formulas as disclosed therein still contain questionable additives or ingredients, hidden caseinates (from milk), and/or soy derivatives.

### SUMMARY

In a first aspect of the invention, a method of making an emulsified mixture is provided. The emulsified mixture comprises a liquefying agent, a bulking agent, at least one of a gelling agent and a thickening agent, a non-soy and non-dairy protein component, a fatty acids component, a surfactant, at least one emulsifying agent, and at least one fruit juice or acidulant. The bulking agent comprises a first sweetener. The method comprises: a) blending the gelling agent into a solution of the first sweetener dissolved in a liquefying agent; b) blending the non-soy and non-dairy protein component into the solution; c) blending the fatty acids component and the surfactant into the solution; and d) blending at least one emulsifying agent into the solution to form the emulsified mixture. The method further comprises e) blending the at least one fruit juice or acidulant into the solution, which may be completed at a later time than steps a) through d).

In the method, the fatty acids component may be pre-heated and pre-mixed with the surfactant before being blended into the solution. The surfactant is vegetarian and non-soy derived.

In the method, the bulking agent may further comprise a second sweetener, and the method may further comprise: f) blending the second sweetener into the solution. It is preferable for the step f) to occur after the step b), c) d) or e). However, it is not intended for the invention to be limited to that order.

Furthermore, in the method, the step d) may comprise adding two emulsifying agents into the solution.

In the method, the emulsified mixture may further comprise a flavoring component, and the method may further comprise: g) blending the flavoring component into the solution.

The above steps a) to e), f) and g) may each be performed for a time duration of 0.5 to 10 minutes. A temperature for making the emulsified mixture may be between 80F to 210F.

The above method may further comprise an aseptic packaging procedure carried out in a hermetic environment. The procedure comprises: h) pasteurizing and homogenizing the mixture; i) sterilizing the mixture; and j) sealing the mixture in a sterilized container. The aseptic packaging procedure ensures that the emulsified mixture is shelf-stable for at least 18 mouths. The sterilization of the mixture may comprise heating the mixture at a high temperature for a short time. The temperature and the time may be selected as suitable for low acid liquid sterilization.

In the method, the at least one fruit juice or acidulant at least one of: extends potential whipping volume of the emulsified mixture by a volume greater than the volume of the at least one fruit juice or acidulant, increases firmness of the emulsified mixture upon the emulsified mixture being whipped, and lowers pH of the emulsified mixture.

In the method, the fruit juice may comprise juice from at least one of the following fruits: apple, apricot, banana, blackberry, blueberry, cherry, coconut milk, cranberry, gooseberry, grapefruit, grape, kiwi, lemon, lime, mango, nectarine, orange, peach, pear, pineapple, plum, pumpkin, raspberry, strawberry, tomato, and watermelon; and the acidulant comprises at least one of the following acids: acetic, citric, lactic, and malic acid.

In the method, the emulsified mixture may further be used in the creation of at least one of the following confections: a mousse, a meringues, a cake topping, a sorbet, a frostings, a pie toppings, and a cream-filling for cakes or cupcakes.

The above method may further comprise a post-process procedure. The procedure comprises: k) heating the mixture to an elevated temperature while stirring the mixture constantly; 1) after reaching said elevated temperature, blending the mixture; and m) packing the mixture in a sterilized container. The sterilized container is at least one of: a pouch, a tub, and an aerosolized can. The mixture is at least one of: pre-whipped and not pre-whipped, before the packaging. In some embodiments the packed container is freezable.

In a second aspect of the invention, an emulsified mixture is provided. The emulsified mixture comprises: a liquefying agent, a bulking agent comprising at least one sweetening agent, a gelling agent, a non-soy and non-dairy protein component, a fatty acids component, a surfactant, at least one emulsifying agent, and at least one fruit juice or acidulant. The bulking agent comprises a first sweetener.

In the emulsified mixture, the emulsified mixture is whipped and the at least one of a fruit juice or an acidulant: extends potential whipping volume of the emulsified mixture by a volume greater than the volume of the at least one fruit juice or acidulant, and increases firmness of the emulsified mixture upon the emulsified mixture being whipped.

In the emulsified mixture, the fruit juice may comprise juice from at least one of the following fruits: apple, apricot, banana, blackberry, blueberry, cherry, coconut milk, cranberry, gooseberry, grapefruit, grape, kiwi, lemon, lime, mango, nectarine, orange, peach, pear, pineapple, plum, pumpkin, raspberry, strawberry, tomato, and watermelon; and the acidulant comprises at least one of the following acids: acetic, citric, lactic, and malic acid.

The emulsified mixture may further be used in the creation of at least one of the following confections: a mousse, a meringues, a cake topping, a sorbet, a frostings, a pie toppings, and a cream-filling for cakes or cupcakes.

In the emulsified mixture, the emulsified mixture is packaged in a sterilized container. The sterilized container is at least one of: a pouch, a tub, and an aerosolized can. The packaged mixture is at least one of: pre-whipped and not pre-whipped, before the packaging. The packaged container is freezable.

### DETAILED DESCRIPTION

The food product according to embodiments of the present invention is a whippable emulsified mixture comprising several ingredients. The mixture is primarily used to form a thick cream-like topping in a post-process involving whipping (e.g., high-speed blending). The whipping causes the mixture to form an air-liquid colloid, greatly expanding in volume. The whipped topping may be used in various food products such as cakes, pastries, or desserts. However, the emulsified mixture according to embodiments of the present invention may also be used for other purposes that a person skilled in the art may foresee, and these other usages should not be considered as departing from the scope of the invention.

One character of the whippable food product according to embodiments of the present invention is that it can be packaged and sold in an un-whipped form. By using an aseptic packaging method, the product is shelf-stable (e.g., the ingredients do not segregate and degrade during storage) at ambient temperatures for an extended period of time (such as, without limitation, eighteen months to two years or more). Another character of the whippable food product according to embodiments of the present invention is that it whips stiff to form a uniform creamy topping in a short period of time (such as, without limitation, a few minutes). Yet another character of the whippable food product according to embodiments of the present invention is that the product is totally free of dairy and animal products/by-products, thus suitable for vegan, kosher parve, or vegetarian consumptions. Also, the product does not contain soy products and/or questionable ingredients such as hydrogenated oils or chemical additives that are considered unsafe by most nutrition and health food professionals.

In one embodiment, the emulsified mixture comprises the following ingredients: 1) a bulking agent; 2) a non-soy, non-dairy protein component; 3) a fatty acids component; 4) a gelling agent; 5) a surfactant, and 6) at least one emulsifying agent. The above ingredients are mixed in a liquefying agent by a process described below to form a uniform emulsified mixture. Furthermore, one or more flavoring components, vitamins and/or minerals, or colorants may be included in the mixture for the purposes of enhancing the flavor, providing nutritional values, or providing visual effects.

The following are descriptions of the ingredients according to embodiments of the invention.

### Liquefying Agent

The liquefying agent may preferably be a low viscosity liquid. One preferred candidate for the liquefying agent is purified water of any kind, such as tap water, spring water, filtered tap water, purified reverse-osmosis treated water, distilled water, de-ionized water, etc. as long as the water is suitable for food preparation. Water adds no discernible taste profile to the finished product, so it is a preferred liquefying agent. However, aside from the water, a wide variety of drinkable liquid may also be considered as the liquefying agent. Some examples may include, without limitation, milk substitutes such as almond milk, rice milk, hazelnut milk, and coconut milk. Dairy milk (all varieties) can be used for the same purpose, but for a non-dairy product, diary milk should not be used. Soy milk can also be used for the same purpose, but for a non-soy product, soy milk should not be used. Fruit juices may also be considered as the liquefying agent.

### Bulking Agent

The bulking agent comprises at least one sweetener, and may comprise two or more sweeteners. A sweetener suitable for the invention may be a natural sugar, a natural sugar substitute, or an artificial sugar substitute.

Examples of the natural sugar include, without limitation, many varieties of naturally occurring sweet tasting substances mainly composed of sucrose and/or fructose, such as cane sugar, beet sugar, cane juice, beet juice, refined sugar, maple syrup or other tree syrups, honey, agave nectar, and the like.

Examples of the natural sugar substitute include, without limitation, various sweeteners produced from starches (a.k.a. starch sugars) such as maltodextrin, glucose syrups (e.g. corn syrup, rice syrup, tapioca syrup, potato syrup, etc.), dextrose, high fructose corn syrup, crystalline fructose, trehalose, sugar alcohols (e.g. xylitol, maltitol, erythritol, sorbitol, mannitol, isomalt, lactitol, etc), and the like.

Examples of the artificial sweetener include, without limitation, saccharin (e.g., Sweet'N Low), aspartame (e.g., Equal, NutraSweet), sucralose (e.g., Splenda, Altern), neotame, acesulfame potassium, stevia, polydextrose, glycerin, propylene glycol, or other monosaccharides, disaccharides, polysaccharides, polyols, and/or combinations thereof.

In one embodiment of the invention, the bulking agent may comprise a first sweetener and a second sweetener. The first sweetener may be a sugar from the above-mentioned natural sugar category. The first sweetener may give the product a sweet-tasting character resembling that of the whipped dairy cream or Chantilly cream. The second sweetener may be a sugar substitute, such as maltodextrin. Maltodextrin adds sweetness while not raising the product's glycemic index as much as sugar would, and it adds body, as it is a starch.

### Protein Component

Embodiments of the present invention is characterized by using one or more varieties of non-soy, non-dairy protein as its protein component. In one exemplary embodiment of the invention, the non-soy, non-dairy protein may be obtained from a plant-based nut or seed other than soy. Suitable plant-based nuts and seeds include, without limitation, almonds, cashews, macadamia nuts, pecans, Brazil nuts, pine nuts, coconut, butternuts, walnuts, beechnut, hickory nuts, chestnuts, sesame seeds, sunflower seeds, and the like.

Among the above-listed nuts and seeds, one preferred nut is almond and one preferred seed is cashew. Although not required, almonds or cashews may be organically grown and processed. Almonds may preferably be blanched to remove their outer skin. They may be whole almonds, pieced almonds, chopped almonds, or ground almonds. Cashews may preferably be raw and skinless. They may be whole cashews, pieced cashews, chopped cashews, or ground cashews. As used herein, the terms “blanched,” “raw,” and “organic” correspond to definitions familiar to those skilled in the relevant art.

For optimum results, the non-soy nut or seed may be processed before being used for the emulsified mixture. For example, almonds or cashews may be finely ground and emulsified, such as being processed into almond butter, cashew butter, almond paste, cashew paste, etc. The ground and buttered non-soy nuts or seeds are included in the whippable topping for their characteristic creamy textures, nutritional properties, neutral to slightly sweet tastes, substance and body, and protein content. The protein component of the topping mixture is known to assist emulsification and stability of the product when whipped.

In the above exemplary embodiment, almonds and cashews may be used alone, or they may be mixed together. One example is that almonds and cashews are mixed in a ratio of about 1 to 1 by weight. Another example is that almonds and cashews are mixed in a ratio of about 2 to 1 (almonds to cashews) by weight. However, it should be apparent to a person skilled in the art that the present invention is not limited by any particular ratio or range of ratios of almonds and cashews.

It is also advantageous to make use of substantially equal parts of liquefied almonds (“almond cream”) and liquefied cashews (“cashew cream”) to form the protein component.

As such, the non-soy, non-dairy nut/seed protein component substantially replaces dairy- or soy-based protein components in the whippable topping product. The resulting food composition is a viable alternative for those who are lactose intolerant, or who wish to avoid products containing soy or dairy.

Aside from the above mentioned non-soy nut or seed protein sources, other suitable protein sources may also be considered, which include, without limitation, vegetable proteins, such as pea protein, potato protein, lentil protein, bean proteins, etc. and protein isolates.

### Fatty Acids Component

In an embodiments of the present invention, the fatty acids component comprises a plant-based oil extracted from plants, plant seeds, or fruits other than soy. Preferably, the plant-based oil is in its least-processed form (meaning the oil is not processed to alter its original molecular structure and composition, such as being partially hydrogenated. One suitable candidate for the natural, plant-based oil is coconut oil. Another suitable candidate is almond oil. The fatty acids component may also be a mixture of two or more kinds of least-processed, plant-based oil extracted from plants, plant seeds or fruits other than soy. One example is a mixture of coconut oil and almond oil. A ratio of coconut oil to almond oil, without limitation, may be from 14-1 to 8-1. The fatty acids component contributes to the stability of the emulsified topping mixture.

Other possible candidates for the fatty acids component include, but are not limited to, olive oil, vegetable oil, corn oil, rapeseed oil, sunflower oil, corn oil, peanut oil, cotton oil, palm oil, and palm kernel oil, etc. It will be noted that soybean oil could also potentially be used, however, would not be suitable for a non-soy embodiment.

### Gelling Agent

The gelling agent is used in an embodiment of the present invention for thickening and stabilizing the whippable topping mixture. In one embodiment of the invention, the gelling agent may be a food additive polysaccharide, such as guar gum, xanthan gum, or other natural-origin gum systems known in the art. The gelling agent may also comprise, without limitation, one or more from the group: Carrageenan, acacia gum, agar, alginates, MCC (micro-cystalline cellulose), CMC (carboxymethyl cellulose), locust bean gum, Inulin, and Pectin.

### Surfactant and Emulsifying Agents

The whippable topping product of embodiments of the present invention further comprises one or more substances for forming and stabilizing the emulsified mixture. In one embodiment of the invention, the whippable topping product comprises a low-water solubility surfactant. This low-water solubility surfactant may be blended into the solution with the fatty acids component, with either the fatty acids component added first, and then the surfactant, or vice versa. It is also possible for the surfactant and the fatty acids component to be added alternating with one another, or preferably, mixed together to form a mixture, which may then be added to the other ingredients. Examples of the surfactant include various lecithin, such as vegetable lecithin, sunflower lecithin, or grape seed lecithin. Soy lecithin can also been used for the same purpose, but for a non-soy product, soy lecithin should not be used. Overall, in the whippable topping mixture of embodiments of the present invention, the surfactant may act as a destabilizing emulsifier. It helps to reduce the viscosity of the mixture and helps to disperse the components evenly.

Aside from the surfactant, the whippable topping product may further comprise at least one emulsifying agent. In one embodiment of the invention, the at least one emulsifying agent may further comprise one or more components, such as a stabilizing emulsifying agent and a destabilizing emulsifying agent. The stabilizing emulsifying agent preferably comprises hexaglyceryl distearate. Also, a variety of other stabilizing emulsifying agents may, alone or in combination, be substituted for or used in addition to hexaglyceryl distearate, for example, without limitation, saturated monoglycerides, saturated diglycerides, polyglycerol esters of fatty acids, cellulose gums, sucrose esters, and/or sodium stearoyl lactylate. The destabilizing emulsifying agent preferably comprises sorbitan monostearate. Also, a variety of other destabilizing emulsifying agents may, alone or in combination, be substituted for or used in addition to sorbitan monostearate, for example, without limitation, unsaturated monoglycerides, unsaturated diglycerides, propylene glycol esters, sorbitan monostearate, polysorbate 65, polysorbate 60 and polysorbate 80, lecithin, and sodium stearoyl lactylate.

Other emulsifiers or emulsifying agents known in the art that may be considered include various fat-based emulsifiers (hydrogenated or partially hydrogenated fat-based emulsifiers, non-hydrogenated fat based emulsifiers, and modified fat-based emulsifiers) such as lecithin and hydroxylated lecithin; various mono, di, or polyglycerides of fatty acids, such as stearin and palmitin mono and diglycerides; polyoxyethylene ethers or fatty esters of polyhydric alcohols, such as the polyoxyethylene ethers of sorbitan monostearate (polysorbate 60, 65, 80) or the polyoxyethylene ethers of sorbitan distearate; fatty esters of polyhydric alcohols such as sorbitan monostearate; polyglycerol esters of mono and diglycerides such as hexaglyceryl distearate; mono- and diesters of glycols such as propylene glycol monostearate, and propylene glycol monopalmitate, succinoylated monoglycerides; and the esters of carboxylic acids such as lactic, citric, and tartaric acids with the mono- and diglycerides of fatty acids such as glycerol lacto palmitate and glycerol lacto stearate; and calcium or sodium stearoyl lactylates and all members of the sucrose ester family thereof; all varieties of diacetyltartaric esters of fatty acids; “DATEMS”; and distilled lactylated or acetylated monglycerides.

Among the above mentioned fat-based emulsifiers, non-hydrogenated fat-based emulsifiers are preferred. The term “non-hydrogenated fat-based emulsifier” used herein means emulsifiers which are derived from a non-hydrogenated fat or oil source and include lecithin (a natural emulsifier derived from animal or vegetable sources), distilled monoglycerides and mono and diglyceride blends. The preferred non-hydrogenated fat-based emulsifier may be a distilled monoglyceride from a plant-based oil or fat.

### Flavorings and Other Components

Although not considered to be essential for achieving the objectives of the invention, a variety of additional components may be added to the whippable topping product for enhancing the taste, nutritional value, and appearance of the product. In one embodiment of the invention, the additional components may comprise flavoring components such as salt and other natural flavorings used alone or in combination, e.g., without limitation, vanilla extract, vanilla bean, chocolate, raw ground fresh fruit, hazelnut, mint extracts (peppermint, spearmint, wintergreen, etc.), lemon juice, lemon rind, orange juice, orange rind, shredded unsweetened coconut, butter, caramel, toffee, coffee, maple, cream, and/or other natural or artificial flavorings. Some examples of types of chocolate, which can be used, without limitation, may include chocolate, cocoa, unsweetened chocolate, semi-sweet chocolate, bittersweet chocolate, cocoa mast, cocoa nibs, and unsweetened cocoa. Some examples of raw ground fresh fruit, which can be used, without limitation, may include strawberries, peaches, raspberries, blueberries, blackberries, cloudberries, bananas, papayas, mangoes, nectarines and cherries. Salt, in addition to providing flavor, acts as a buffer and sequestrant. Examples of useful salts are common salt (sodium chloride), and sodium, calcium or potassium monophosphates, diphosphates, polyphosphates, citrates, chlorides, and the like.

Other ingredients that may be used in embodiments of the present invention may include colorants, vitamins, and minerals. These ingredients are known in the art and hence are not discussed further herein.

As a non-restrictive example, Table 1 lists the approximate weight percent ranges for each component of a whippable topping product according to an embodiment of the present invention. It will be recognized that these disclosed weight percentage ranges listed in Table 1 are not meant to be limiting, and may vary, and include without limitation, for example, any smaller range within each respective range.

TABLE 1
Weight Percent Ranges for Components
of the Whippable Topping Mixture

| Component | Weight Percentage Range |
|---|---|
| Liquefying Agent | 42%-70% |
| Bulking Agent | 5%-22% |
| Protein Components | 0.2%-8% |
| Fatty Acids Components | 0.25%-21% |
| Surfactant | 0.1%-4% |
| Gelling Agent | 0.05%-1.5% |
| Emulsifying Agent(s) | 0.1%-4% |
| Other Components | 0.01%-1% |

It should be noted that the percentages shown in Table 1 are not limiting in any way and may be adjusted by those skilled in the art without departing from the scope of the invention.

In one embodiment of the invention, the inventive whippable topping mixture has been subjected to a packing procedure for being packed into finished products. The packing procedure may vary depending on the manufacturing conditions.

### A Process of Making the Emulsified Mixture and the Whippable Topping

According to a preferred embodiment of the present invention, a process for making the emulsified mixture comprises the following steps:
a) blending a gelling agent into a solution, the solution comprising a bulking agent dissolved in a liquefying agent;
b) blending a non-dairy, non-soy protein component into the solution;
c) blending a fatty acids component and a surfactant into the solution;
d) blending at least one emulsifying agent into the solution to form the emulsified mixture; and
e) optionally blending the at least one fruit juice or acidulant into the solution.

It should not be construed that the above steps a) to e) must be carried out in the order as indicated, although it is preferred to carry out the steps a) to e) in that order.

In the above process, the mixing equipment may be a blender, a turbo mixer, or any commonly available mechanical device suitable for mixing food ingredients. It is preferred that the process is carried out in an elevated temperature. For example, the mixing equipment may be pre-warmed to the elevated temperature. The elevated temperature may be, for example, without limitation, approximately 120 degrees F. (˜50° C.). It will be recognized that 120 degrees F. has been chosen for the purposes of disclosure, but is in no way meant to be limiting. The invention comprises any suitable temperature, which may be recognized by one skilled in the art. Warming up the mixing equipment may be accomplished by many different ways, for example, adding boiling water into the mixing equipment to raise the temperature, and then pouring off the water.

In the above process, the solution of the bulking agent dissolved in the liquefying agent may be obtained by adding a first sweetener into the liquefying agent in the pre-heated mixing equipment and blending until the first sweetener is completely dissolved. It is also preferred that the liquefying agent is pre-heated to a temperature slightly below the boiling point, for example, without limitation, about 200 degrees F. (˜93° C.). It will be recognized that 200 degrees F. has been chosen for the purposes of disclosure, but is in no way meant to be limiting. The invention comprises any suitable temperature which may be recognized by one skilled in the art.

In the above process, it is preferable for the fatty acids component to be pre-heated to a temperature at which it is in its liquid state prior to being mixed with the surfactant or blended directly into the solution. Without being limited to the theory, it is believed that such temperature and state allows the fatty acids component to disperse more quickly and evenly. It will be recognized that this is in no way meant to limit the invention, and a fatty acids component in a state other than liquid is still included within the scope of the invention.

The above process may further comprise a step of: f) blending a second sweetener into the solution. Preferably, the step f) is performed after the step b), c), d), or e).

In step d) of the method, the at least one emulsifying agent of the emulsified mixture may comprise a first emulsifying agent and a second emulsifying agent. It is preferable that this sub-step comprises adding a stabilizing emulsifying agent, and adding a destabilizing emulsifying agent. The stabilizing emulsifying agent and destabilizing emulsifying agent may be added either together (either mixed together and then added to the solution; or simply added at the same time to the solution) or in tandem, and if in tandem, the stabilizing agent may be added before the destabilizing agent or vice versa.

The above process may further comprise a step of: g) blending one or more other components into the solution.

Some or all of the above steps a) to g) may be combined. Each of the above steps a) to g) (or combinations thereof) may be performed for a time duration of a few minutes, respectively. Typically, without limitation, the time period may be approximately 0.5-10 minutes. It will be recognized that this disclosed range is not meant to be limiting, and may vary, and include without limitation, for example, any smaller range within the disclosed range.

The emulsified mixture obtained from the above-described process may further undergo a packaging procedure for being packed into finished products. The packaging procedure varies depending on the manufacturing conditions. For example, in a mass production environment, an aseptic packing procedure may be carried out. Typically, this aseptic procedure may comprise the following steps:
h) pasteurizing and homogenizing the mixture in a hermetic environment (i.e. under vacuum or inert atmosphere);
i) sterilizing the mixture in the hermetic environment; and
j) sealing the sterilized mixture in a sterilized container in the hermetic environment.

The sterilization of the mixture may be carried out by e.g. a “high temperature, short time” (HTST) process. The temperature and the time may be selected according to the parameters suitable for low-acid liquid sterilization. The emulsified mixture prepared according to the aseptic packaging process can be stored at ambient temperatures. Testing results show that the aseptically packaged mixture can have a shelf life of at least eighteen months without losing freshness, taste, and characteristics. Aseptic packaging processes and HTST are believed to be well-known to those of skill in the art, and are not further disclosed herein.

In other manufacturing conditions, e.g. while not in the aseptic process environment, the emulsified mixture prepared by the above-disclosed process may undergo an alternative post-process procedure comprising one or more of the following steps (i.e. without following the aseptic procedure as in steps g) through i) above):
k) heating the mixture to an elevated temperature while stirring the mixture constantly;
l) after reaching said elevated temperature, blending the mixture; and
m) packing the mixture in a sterilized container.

For example, in the above step k), the blending is performed at a high speed for a period of time that is, without limitation, 0.5-10 minutes. The heating and/or blending actions are believed to activate the starches in the mixture, equivalent to pasteurization and homogenization. Test results show that in ambient temperatures, the finished product has a shelf life shorter than that of the ones processed by the aseptic packing procedure. Therefore, refrigeration may be required. However, the product still has other characteristics, such as it can be whipped to form the whipped topping in a short time and the taste and volume expansion are not affected.

### Addition of Lemon Juice, Fruit Juice, or Other Acidulant

In some embodiments, lemon juice, fruit juice, or another acidulant is added to the emulsified mixture, thereby lowering the pH of the emulsified mixture and increasing potential whipping volume of the emulsified mixture. In additional embodiments, the liquefying agent is comprised in part or entirely of lemon juice, fruit juice, or another acidulant. An acidulant, as will be recognized by a person skilled in the art, is a food engineering term for one of a class of chemicals added to food to increase either tartness or acidity, such as malic or citric acids for tartness and phosphoric acid for acidity. Commonly used acidity regulators are citric, acetic and lactic acids. Lactic acids may be derived from both animal and vegetable sources.

The addition of acidic lemon juice to the emulsified mixture has been found upon whipping to cause a greater volume increase of the whipped emulsified mixture than merely the addition of water (a neutral pH liquids) alone. A new and unexpected consequence of adding lemon juice/acidic liquid to the emulsified mixture is an extension, but not amplification, of the whip potential of the emulsified mixture. As more acidic liquid is added, the whip volume increases at approximately the same rate of increase that is expected from adding more emulsified mixture. In other words, adding lemon juice/acidic liquid to the emulsified mixture produces approximately the same whipped volume as increasing the amount of emulsified mixture being whipped. The same whipped volume is produced regardless of whether the lemon juice/acidic liquid is added to the emulsified mixture and stirred in thoroughly before whipping or added to the emulsified mixture after the start of whipping.

For example, 150 ml of an embodiment of the emulsified mixture whips (pH 5.95) up to about 400 ml at 42F. The addition of 15 ml of lemon juice (pH 2.25) to the 150 ml of emulsified mixture adds an additional about 40 ml to the final whipped mixture for a total of 440 ml of whip. Likewise, adding 30 ml more lemon juice to the 150 ml of emulsified mixture yields 80 ml more whip for a total of 480 ml of whip. Therefore, the lemon juice linearly extends the whip. By comparison, when additional water (pH ˜7) is added to the emulsified mixture and the mixture whipped, the additional whip created is only equal to the volume of added water. For example, when 30 ml of water are added to 150 ml of emulsified mixture, the additional volume of whip produced is just 30 ml more whip volume. It should be noted that the measurements presented here are intended to be exemplarily only and are not intended to limit the invention.

Also of note, the mere addition of water to the emulsified mixture followed by whipping results in a whipped foam that is comparatively weaker (e.g., tendency to deform, creep, and relax) than a whipped emulsified mixture without additional water. By comparison, the addition of lemon juice/acidic liquid to the emulsified mixture followed by whipping initially soften the resultant whip, but the resultant whip quickly firms up (e.g., becomes stiff) when still (e.g., left to sit).

The addition or substitution of an acidulant in the emulsified mixture lowers the pH of the mixture and the whip created from whipping the emulsified mixture. In one embodiment, 1 part lemon juice with a pH of 2.25 is added to 10 parts emulsified mixture with a pH of 5.95. The new resultant emulsified mixture and whipped product has a pH of 3.1. While in some embodiments of the present invention, lemon juice and other acidulants of a low pH are used to extend the whipping potential of the emulsified mixture, in other embodiments, juices and acidulant of a higher (i.e. closer to neutral) pH are employed to extend the whipping potential of the emulsified mixture with approximately same extension results. The pH of the added juice/acidulant need not be as low as 2.3 (lemon juice) to produce whipping extension. A liquid with pH in as high as 3.0 to 3.5 is still expected to produce approximately the same ratio of additional whip to liquid as lemon juice would. An acidic liquid with a moderately high pH is expected to produce some extension of whipping potential in the emulsified mixture, although the degree of extension may depend on the liquid's pH. Juices and acidulants of varying acidity can therefore be used to extend whip volume. It should also be noted that the addition or substitution of juices/acidulants of a higher pH would be expected to also produce whip of a higher pH.

In some embodiments, the addition or substitution of an acidulant may be at least one (1) part lemon juice/acidic liquid to two (2) parts emulsified mixture, if not even a greater ratio, and still produce an extension to the whipped emulsified mixture. However, as the ratio of the volume of juice/acidulant to emulsified mixture increases and nears 50%, some small decrease in the extension potential is seen. For example, 80 ml of lemon juice added to 150 ml of emulsified mixture produces 580 ml whip volume, or 400 ml of whip from the 150 ml of emulsified mixture and 180 additional ml of whip from the addition of the lemon juice. Likewise, a 500 ml package of emulsified mixture could be added to about 300 ml juice to produce about 2000 ml of whip.

In some embodiments, fruit juice or another acidulant is added to an emulsified mixture by a manufacturer and the resultant mixture then packaged. In still another embodiment, a consumer, such as a chef, cook, or other user, adds fruit juice or another acidulant to a prepackaged emulsified mixture before or during whipping the mixture into whipped foam. The former offers consumers packaged, whip-able toppings in a variety of fruit flavors. Additional ingredients need not be added. The latter offers consumers the option of creating a whip with fruit flavor of their choosing. Also, this latter option decreases the bulk and volume of the un-whipped emulsified mixture, thereby decreasing storage and shipping space requirements for the emulsified mixture product.

While embodiments of the present invention have primarily been discussed with lemon juice as the main acidulant, it should be apparent to a person skilled in the art that embodiments of the present invention are not limited by any particular fruit juice or acidulant emulsified mixture add-in. Nor for that matter need only one type of juice be used. Combinations of one or more fruit juices and other acidulants may be added to an emulsified mixture. In a non-limiting example, in one embodiment, a combination of lemon and raspberry flavored juices is added to the emulsified mixture to create a raspberry-lemonade flavored whip. In still another non-limiting example of another embodiment, strawberry, orange, and banana juices are added to an emulsified mixture to produce a strawberry-orange-banana flavored whip. In some embodiments, juices (followed by their approximate pH) from the following fruits, in combination or isolation, are added to or substituted in the emulsified mixture: apple (3.3-3.9), apricot (3.8), banana (4.5-5.2), blackberry (3.9-4.5), blueberry (3.1-3.4), cherry (˜3.7), coconut milk (6.1-7.0), cranberry (2.3-2.5), gooseberry (2.8-3.1), grapefruit (3.0-3.7), grape (3.5-4.5), kiwi (−4.5), lemon (2.0-2.6), lime (2.0-2.4), mango (5.8-6.0), nectarine (3.9-4.2), orange (3.0-4.0), peach (3.4-4.1), pear (3.6-4.0), pineapple (3.3-3.6), plum (2.8-3.0), pumpkin (4.8-5.2), raspberry (3.2-3.6), strawberry (3.0-3.9), tomato (4.1-4.6), and watermelon (5.2-5.6). In some embodiments, one or more of the following acidulants (followed by their pH) is added to or substituted in the emulsified mixture: acetic (2.4), citric (2.2), lactic (2.4), and malic (2.2) acid. Some embodiments comprise combinations of fruit juices and acidulants added to the emulsified mixture. The lists presented here are not intended to be all-inclusive and should not be construed as limiting. Additional fruit juices and acidulants exist which are not listed here but which will be recognized by those trained in the art as within the spirit of the invention.

The emulsified mixture discussed hereinabove, unlike traditional whipping cream, can whip with fruit juice and other tart, acidic components with no adverse impact on the properties of the resultant whip. The whipped non-dairy, non-soy emulsified mixture therefore has useful applications beyond substituting for traditional whipping cream. Other potential usages of the whipped non-dairy, non-soy emulsified mixture with fruit juice/acidulant include, but are not limited to: in mousse and similar desserts, in meringues, as cake toppings, and stirred/whipped into sorbet.

In one exemplarity embodiment, the whipped emulsified mixture infused with fruit juice or another acidulant is used in the creation of new products such as, but not limited to, prepared flavored meringues. The fruit juice/acidulant infused whipped emulsified mixture becomes firm upon sitting, having a consistency similar to a traditional egg-based meringue. Vegans, people with high cholesterol levels, people with allergies or other dietary concerns, may not be able to consume traditional meringues. Therefore, this embodiment offers a non-dairy, non-soy, non-egg substitute. The meringue-like fruit juice/acidulant infused whipped emulsified mixture may be used in/as, but not limited to, the following confections: frostings, pie toppings, and cream-filling in cakes and cupcakes. In one embodiment, the un-whipped fruit juice/acidulant infused emulsified mixture or any of the above confections are aseptically produced for the food service industry, bakery and confection sectors, and packaged in larger-sized formats. In another embodiment the un-whipped fruit juice/acidulant infused emulsified mixture or any of the above confections are aseptically produced and packaged in small-sized formats for home/family consumer use.

In one exemplarity embodiment, the emulsified mixture infused with fruit juice or another acidulant is used in the creation of new products such as, but not limited to, a non-dairy, non-soy vegan mousse or similar dessert. This embodiment therefore offers fruit-flavored prepackaged desserts that only require whipping for preparation or may come pre-whipped and ready to serve. In a preferred embodiment, the emulsified mixture infused with fruit juice/acidulant is aseptically produced and packaged and sold whipped or un-whipped, e.g., in 4-packs single-serve “custard cups” commonly seen in supermarkets. The aseptically produced and packaged fruit juice/acidulant infused emulsified mixture is believed to be completely shelf-stable. Therefore, even without the addition of preservatives, it does not require refrigeration over extended periods (e.g., 6-24 months).

The emulsified mixture sustains whipped characteristics after the addition of fruit juices, whereas by comparison, dairy whipped cream will curdle, or at the very least, collapse with the addition of (citric) fruit juices or other low pH additives. Therefore, the emulsified mixture with fruit juice offers a healthy, non-dairy, non-soy, real fruit juice flavored whipped topping and dessert component. While several embodiments of the emulsified mixture infused with fruit juice/acidulant have been discussed above, additional applications and uses will be recognized by people trained in the art and are considered within the scope of the invention.

### Packaging and Storage

In a preferred embodiment, the emulsified mixture is aseptically produced and packaged as an un-whipped mixture, as discussed further above. In this embodiment, packaging the un-whipped emulsified mixture in aseptically sealed pouches, containers, etc. decreases the bulk of shipping and storing the product and allows an overall greater quantity of the product to be shipped and stored. However, in some embodiments the emulsified mixture may be packaged in a format similar to that of traditional whipping cream products.

In one embodiment, the non-dairy, non-soy emulsified mixture is aseptically prepared, pre-whipped and sold in a tub, similar to Cool Whip products (Cool Whip is a registered trademark of Kraft General Foods, Inc.). In another embodiment, the non-dairy, non-soy emulsified mixture is aseptically prepared and packaged in an aerosolized can (using nitrous oxide as a propellant in some embodiments), similar to Reddi Wip or Soyatoo products (Reddi Wip is a registered trademark of ConAgra Foods RDM, Inc., Soyatoo is a registered trademark of Tofutown). In yet another embodiment, the non-dairy, non-soy emulsified mixture is aseptically prepared and packaged and frozen for an extended period of time, either in a whipped or un-whipped form. Although the emulsified mixture is shelf-stable and therefore does not generally require freezing/refrigeration, it may at times be desirable to freeze the emulsified mixture in order to extend the shelf life or for other reasons. Other packaging for and methods of storing the whipped or un-whipped emulsified mixture will occur to people trained in the art and as technology allows. Such additional packaging and storage methods are considered within the scope of the invention and their lack of recitation here is not to be construed as limiting.

### EXAMPLES

Having disclosed the process in general, a particular exemplary process for making the emulsified mixture according to one embodiment of the invention may comprise the following actions:
(1) In a pre-warmed blender or turbo mixer, adding pre-heated liquefying agent (e.g. water);
(2) To water, adding the first sweetener (e.g. sugar or cane solids), and blending for 2 minutes;
(3) To the mixture, adding the gelling agent (e.g. guar gum), and blending for 2 minutes;
(4) To the mixture, adding non-soy protein (e.g. almond and cashew butters or pastes), and blending for 2 minutes;
(5) To the mixture, adding the second sweetener (e.g. maltodextrin), and blend for 1 minute;
(6) To the mixture, adding the pre-heated liquid-state fatty acids component (e.g. coconut and almond oils pre-mixed with lecithin), and blending for 1 minute;
(7) To the mixture, adding the emulsifying agent (e.g. hexaglyceryl distearate and/or sorbitan monostearate), and blending for 2 minutes; and
(8) To the mixture, adding other components (e.g. flavorings and/or salt), and blending for 1 minute.

The emulsified mixture is then packed as finished products. For example, the above exemplary mixture-making process (steps 1-8) may continue with the following aseptic package process:
(9) Transferring the mixture to an aseptic process equipment under vacuum or inert atmosphere, pasteurizing the mixture at a high temperature above the water boiling point (e.g., 285-295 degrees F.) for a few seconds (e.g., 8 seconds), and, after slightly cooling, homogenizing the mixture;
(10) Sterilizing the mixture under vacuum or inert atmosphere using e.g. a “high temperature, short time” process suitable for sterilizing low acid liquids; and
(11) Packing the mixture into a sterile container.

Alternatively, as mentioned above in a non-aseptic packing process, the steps (9) to (11) may be replaced by the following steps:
(12) Transferring the mixture to a container (e.g., a kettle), and heating it to an elevated temperature (for example, without limitation, 190 degrees F.) while stirring the mixture constantly;
(13) After reaching said elevated temperature, transferring the mixture to blending equipment (e.g., a blender) and blending the mixture at a high speed for 1-2 minutes; and
(14) Packing the mixture in a container.

After, for example, purchasing the packaged product, an end user may follow the following steps to prepare the whipped topping:
1. Refrigerating the emulsified mixture in cartons for a sufficient amount of time for the product to chill (e.g., reach 45 degrees F.); and
2. Pouring the contents from the carton and whipping with a suitable method (e.g., using a hand-held beater, a whip or an electric mixer or beater) for 30 seconds to 3 minutes, the desired stiffness of the whipped topping can be achieved.

It has been found that the volume expansion of the whipped topping is about 200-400% (i.e. half cup of the mixture can be whipped into approximately 1-2 cups or more of whipped topping).

Table 2 shows exemplary ingredients of each component of the mixture, along with preferred weight percentage ranges.

TABLE 2
Weight Percent Ranges for Ingredients
of the Whippable Topping Mixture

| | Exemplary | Wt % | Preferred wt % |
|---|---|---|---|
| Component | Ingredient | Range | Range |
| Liquefying Agent | Water | 42-70 | 50-52 |
| Bulking Agent | Sugar | 6-22 | 12.5-14.2 |
| | Maltodextrin | 5-19 | 8-10 |
| Protein | Almond | 0.2-8 | 0.9-2.9 |
| Components | | | |
| | Cashew | 0.2-8 | 0.9-2.9 |
| Fatty Acids | Almond Oil | 0.25-3 | 1.2-2.2 |
| Components | | | |
| | Coconut Oil | 7-21 | 15.8-17.8 |
| Surfactant | Lecithin | 0.1-4 | 0.2-0.8 |
| Gelling Agent | Guar Gum | 0.1-2 | 0.1-0.3 |
| Emulsifying | Sorbitan Monostearate, | 0.1-4 | 0.25-0.45 |
| Agent(s) | hexaglyceryl distearate | | |
| Other Components | Salt and Flavorings | 0.01-1 | 0.25-0.45 |

Table 3 lists some composition examples according to an embodiment of the present invention.

TABLE 3
Example Compositions of the Whippable Topping Mixtures

| Ingredient | | | | | | | |
|---|---|---|---|---|---|---|---|
| (wt %) | Ex. 1 | Ex. 2 | Ex. 3 | Ex. 4 | Ex. 5 | Ex. 6 | Ex. 7 |
| Water | 52.28 | 62.08 | 51.58 | 61.12 | 51.74 | 62.66 | 52.17 |
| Sugar | 13.99 | 11.09 | 13.87 | 10.80 | 13.88 | 10.96 | 13.99 |
| Maltodextrin | 9.99 | 7.92 | 9.91 | 7.80 | 9.91 | 7.83 | 9.99 |
| Almond | 1.99 | 1.58 | 1.98 | 1.56 | 1.98 | 1.56 | 1.99 |
| Cashew | 1.99 | 1.58 | 1.98 | 1.56 | 1.98 | 1.56 | 1.99 |
| Coconut Oil | 16.49 | 13.08 | 16.35 | 12.80 | 16.36 | 12.92 | 16.48 |
| Almond Oil | 1.497 | 1.18 | 1.49 | 1.17 | 1.48 | 1.17 | 1.49 |
| Lecithin | 0.306 | 0.243 | 0.3 | 0.23 | 0.3 | 0.23 | 0.3 |
| Guar Gum | 0.109 | 0.17 | 0.22 | 1.71 | 0.21 | 0.17 | 0.21 |
| Emulsifying | 1.098 | 0.86 | 1.90 | 0.85 | 0.98 | 0.85 | 1.08 |
| Agent(s) | | | | | | | |
| Salt | 0.050 | 0.039 | 0.05 | 0.03 | 0.04 | 0.03 | 0.05 |
| Flavorings | 0.147 | 0.18 | 0.37 | 0.10 | 0.97 | 0.06 | 0.14 |

In summary, the present application provides a non-dairy, non-soy food product. The food product can be whipped to form a whipped topping. This product can be packaged and sold in an un-whipped form by regular aseptic packaging. This product is shelf-stable at ambient temperatures for at least two years, and it whips stiff to form a uniform creamy topping or frosting (after being briefly refrigerated) in less than one minute. The product is totally free of dairy and animal products/by-products, thus it is suitable for consumption by people with special dietary needs. Also, the product does not contain soy products and/or questionable ingredients such as processed oils, chemical additives, etc.

The products of embodiments of the present invention greatly alleviates the need for storage space in freezers or refrigerators, which are both considered prime “real-estate” in any kitchen or food service facility. It is also truly non-dairy and contains no additives of “questionable nature”.

The finished products of embodiments of the present invention can be sold as a food product at supermarkets or health food stores. The closest products to this invention shown in the prior art would all contain soy or dairy derivatives or unwanted additives/ingredients, and most would need refrigeration or freezing. Any health-conscious, kosher or vegan consumer, any lactose-intolerant or gluten-intolerant consumer, any consumer who was also looking to avoid soy in their foods can advantageously use the products resulted from embodiments of the present invention.

As used herein, an element or step recited in the singular and proceeded with the word “a” or “an” should be understood as not excluding plural elements or steps, unless such exclusion is explicitly stated. Furthermore, references to “one embodiment” or “preferred embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Since other modifications and changes varied to fit particular usages will be apparent to those skilled in the art, the invention is not considered limited to the embodiment chosen for purposes of disclosure, and it covers all changes and modifications which do not constitute departures from the true spirit and scope of this invention.

Having thus described the invention, what is desired to be protected by Letters Patent is presented in the subsequently appended claims.

I claim:

1. A method for making an emulsified mixture,
wherein the emulsified mixture comprises a liquefying agent, a bulking agent, at least one of a gelling agent and a thickening agent, a non-soy and non-dairy protein component, a fatty acids component, a surfactant, at least one emulsifying agent, and at least one fruit juice or acidulant,
wherein the bulking agent comprises a first sweetener, and
wherein the method comprises:
a) blending the gelling agent into a solution of the first sweetener dissolved in a liquefying agent;
b) blending the non-soy and non-dairy protein component into the solution;
c) blending the fatty acids component and the surfactant into the solution; and
d) blending at least one emulsifying agent into the solution to form the emulsified mixture.

2. The method of claim 1, the method further comprising:
e) blending the at least one fruit juice or acidulant into the solution.

3. The method of claim 2, wherein the blending the at least one fruit juice or acidulant into the solution of step e) is completed at a later time than steps a) through d).

4. The method of claim 1, wherein the fatty acids component is pre-heated and premixed with the surfactant prior to being blended into the solution in step c).

5. The method of claim 1, wherein the surfactant is vegetarian and non-soy derived.

6. The method of claim 1, wherein the bulking agent further comprises a second sweetener, and the method further comprises:
f) blending the second sweetener into the solution.

7. The method of claim 1, wherein the at least one emulsifying agent in step d) comprises two emulsifying agents.

8. The method of claim 1, wherein the emulsified mixture further comprises a flavoring component, and the method further comprises:
g) blending the flavoring component into the solution.

9. The method of claim 1, wherein the steps a) to d) are each performed for a time duration of 0.5 to 10 minutes at a temperature between 80F and 210F.

10. The method of claim 1, further comprising:
h) pasteurizing and homogenizing the mixture in a hermetic environment;
i) sterilizing the mixture in the hermetic environment; and
j) packing the sterilized mixture in a sterilized container in the hermetic environment.

11. The method of claim 10, wherein sterilizing the mixture comprises sterilizing the mixture according to a procedure suitable for sterilizing low-acid liquids in the hermetic environment.

12. The method of claim 1, wherein the at least one fruit juice or acidulant: extends potential whipping volume of the emulsified mixture by a volume greater than the volume of the at least one fruit juice or acidulant, increases firmness of the emulsified mixture upon the emulsified mixture being whipped, and lowers pH of the emulsified mixture.

13. The method of claim 1, wherein the emulsified mixture is comprised of up to one-third of the at least one fruit juice or acidulant.

14. The method of claim 1, where the fruit juice comprises juice from at least one of the following fruits: apple, apricot, banana, blackberry, blueberry, cherry, coconut milk, cranberry, gooseberry, grapefruit, grape, kiwi, lemon, lime, mango, nectarine, orange, peach, pear, pineapple, plum, pumpkin, raspberry, strawberry, tomato, and watermelon; and the acidulant comprises at least one of the following acids: acetic, citric, lactic, and malic acid.

15. The method of claim 1, wherein the emulsified mixture is used in the creation of at least one of the following confections: a mousse, a meringue, a cake topping, a sorbet, a frosting, a pie topping, and a cream filling for cakes or cupcakes.

16. The method of claim 1, further comprising:
k) heating the mixture to an elevated temperature while stirring the mixture constantly;
l) after reaching said elevated temperature, blending the mixture; and
m) packing the mixture in a sterilized container;
wherein the sterilized container is at least one of: a pouch, a tub, and an aerosolized can;
wherein the mixture is at least one of: pre-whipped and not pre-whipped, before the packaging; and
wherein the packed container is freezable.

17. An emulsified mixture, comprising:
a liquefying agent,
a bulking agent comprising at least one sweetening agent,
a gelling agent,
a non-soy and non-dairy protein component,
a fatty acids component,
a surfactant,
at least one emulsifying agent, and
at least one of a fruit juice or an acidulant.

18. The emulsified mixture of claim 17, wherein the emulsified mixture is whipped and the at least one of a fruit juice or an acidulant:
extends potential whipping volume of the emulsified mixture by a volume greater than the volume of the at least one of a fruit juice or an acidulant, and
increases firmness of the emulsified mixture upon the emulsified mixture being whipped and set.

19. The emulsified mixture of claim 17, where the fruit juice comprises juice from at least one of the following fruits: apple, apricot, banana, blackberry, blueberry, cherry, coconut milk, cranberry, gooseberry, grapefruit, grape, kiwi, lemon, lime, mango, nectarine, orange, peach, pear, pineapple, plum, pumpkin, raspberry, strawberry, tomato, and watermelon; and the acidulant comprises at least one of the following acids: acetic, citric, lactic, and malic acid.

20. The emulsified mixture of claim 17, wherein the emulsified mixture is used in the creation of at least one of the following confections: a mousse, a meringue, a cake topping, a sorbet, a frosting, a pie topping, and a cream filling for cakes or cupcakes.

21. The emulsified mixture of claim 17, the emulsified mixture being packaged in a sterilized container and the sterilized container being at least one of: a pouch, a tub, and an aerosolized can;
wherein the mixture is at least one of: pre-whipped and not pre-whipped, before the packaging; and
wherein the packaged container is freezable.
